(19) United States
(12) Patent Application Publication
(10) Pub. No.: US 2015/0072279 A1
(43) Pub. Date: Mar. 12, 2015

(54) DEVELOPER, DEVELOPER CONTAINER UNIT, DEVELOPING DEVICE, AND IMAGE FORMING APPARATUS

(71) Applicant: OKI DATA CORPORATION, Tokyo (JP)

(72) Inventor: Hideharu KUWABARA, Tokyo (JP)

(21) Appl. No.: 14/482,008

(22) Filed: Sep. 10, 2014

(30) Foreign Application Priority Data
Sep. 11, 2013 (JP) 2013-188544

(51) Int. Cl. G03G 9/00

(52) U.S. Cl. CPC G03G 9/0825; G03G 2215/0636
USPC 430/105; 430/108.22

(57) ABSTRACT

Developer includes a toner base particle and an outer additive agent attached to a surface of the toner base particle. The outer additive agent includes at least a composite oxide particle containing titanium dioxide and silicon dioxide and a melamine resin particle.

### BACKGROUND OF THE INVENTION AND RELATED ART STATEMENT

The present invention relates to developer, a developer container unit, a developing device, and an image forming apparatus. More specifically, the present invention relates to developer a developer container unit, and a developing device that can be used in an image forming apparatus of an electro-photography type, and relates to an image forming apparatus of an electro-photography type.

A conventional image forming apparatus is configured to use transparent toner (refer to Patent Reference).

Patent Reference Japanese Patent Publication No. 2009-063744

In the conventional image forming apparatus disclosed in Patent Reference, depending on a change in an environment where the conventional image forming apparatus is used, it may be difficult to obtain a high quality image.

In view of the problems described above, an object of the present invention is to provide developer, a developer container unit, a developing device, and an image forming apparatus.

Further objects and advantages of the invention will be apparent from the following description of the invention.

### SUMMARY OF THE INVENTION

In order to attain the objects described above, according to a first aspect of the present invention, developer includes a toner base particle and an outer additive agent attached to a surface of the toner base particle. The outer additive agent includes at least a composite oxide particle containing titanium dioxide and silicon dioxide and a melamine resin particle.

According to a second aspect of the present invention, a developer container unit is configured to retain developer to be supplied to a developer supporting member for supporting the developer, and the developer is the developer in the first aspect.

According to a third aspect of the present invention, a developing device is configured to form a developer image on a developer supporting member using developer supplied from a developer container unit, and the developer is the developer in the first aspect.

According to a fourth aspect of the present invention, a developing device is configured to form an image through transferring a developer image to a medium. The developer image is formed on a developer supporting member using developer supplied from a developer container unit, and the developer is the developer in the first aspect.

According to the present invention, it is possible to prevent image quality from being deteriorated due to an environmental change.

### BRIEF DESCRIPTION OF THE DRAWINGS

FIG. 1 is a schematic sectional view showing an internal configuration of an image forming apparatus according to an embodiment of the present invention;

FIG. 2 is a schematic sectional view showing an internal configuration of a developing device of the image forming apparatus according to the embodiment of the present invention;

FIG. 3 is a schematic sectional view showing an internal configuration of a toner cartridge of the developing device of the image forming apparatus according to the embodiment of the present invention;

FIG. 4 is a schematic sectional view showing an internal configuration of a developing portion of the developing device of the image forming apparatus according to the embodiment of the present invention; and

FIG. 5 is a schematic sectional view showing an internal configuration of a fixing portion of the image forming apparatus according to the embodiment of the present invention.

### DETAILED DESCRIPTION OF PREFERRED EMBODIMENTS

Hereunder, embodiments of the present invention will be explained with reference to the accompanying drawings. It should be noted that the present invention is not limited to the following description, and the embodiments can be modified within a scope of the present invention.

In the embodiments described later, the present invention is applied to a color electro-photographic printer using developer (toner) produced with a solution emulsion method. It should be noted that an image forming apparatus according to the present invention is not limited to a printer, and the present invention may be widely applied to an image forming apparatus such as a copier, a facsimile, and the like.

### Configuration of Image Forming Apparatus

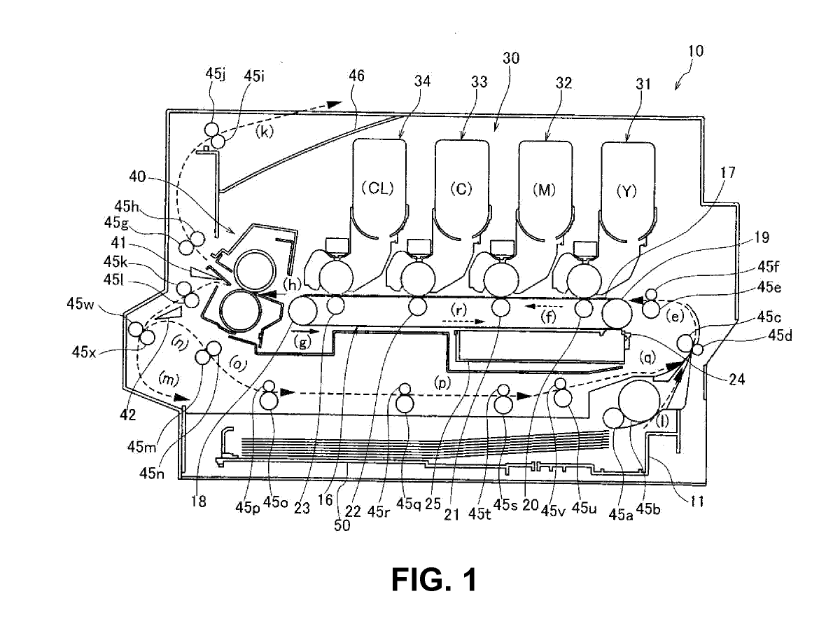

FIG. 1 is a schematic sectional view showing an internal configuration of an image forming apparatus 10 according to an embodiment of the present invention.

As shown in FIG. 1, the image forming apparatus 10 includes a medium retaining cassette 11; developing devices 31, 32, 33, and 34, a transfer portion 16; and a fixing portion 40. Further, the image forming apparatus 10 includes transportation rollers 45a to 45x for transporting a medium 50 to each component from the medium retaining cassette 11; and transportation path switching guides 41 and 42.

In the embodiment, the medium retaining cassette 11 is configured to retain the medium 50 such as a recording sheet and the like in a stacked state. Further, the medium retaining cassette 11 is arranged to be freely attached to and detached from a lower portion inside the image forming apparatus 10. The medium transportation rollers 45a and 45b are provided for picking up the medium 50 retained in the medium retaining cassette 11 one by one from the upper most one, and for transporting the medium 50 in an arrow direction (l). The transportation rollers 45c, 45d, 45e, and 45f are provided for correcting skew of the medium 50 while the medium 50 is being transported along an arrow direction (e), and for feeding the medium 50 to an image forming portion 30.

In the embodiment, the image forming portion 30 is provided for forming an image on the medium 50 thus transported. Further, the image forming portion 30 includes the four developing devices 31, 32, 33, and 34 arranged along a transportation path to be freely attached and detached; and the transfer portion 16 for transferring toner imaged formed with the developing devices 31, 32, 33, and 34 to an upper surface of the medium 50 through Coulomb's force.

In the embodiment, the developing devices 31, 32, 33, and 34 are arranged along the transportation path in this order, and are provided for performing a developing process using toner in yellow (Y), magenta (M), cyan (C), and transparent (CL), respectively. The developing devices 31, 32, 33, and 34 have an identical configuration (described later), and use toner in different colors.

In the embodiment, when an image in black is formed on the medium 50, the developing devices 31, 32, and 33 are used to mix yellow (Y), magenta (M), and cyan (C). It should be noted that the number of the developing devices 31, 32, 33, and 34 is not limited to four. For example, in addition to the developing devices 31, 32, 33, and 34 shown in FIG. 1, a developing device using toner in black (K) may be disposed. Further, when the present invention is applied to a monochrome printer for forming an image with gloss, developing devices using toner in black (K) and transparent (CL) may be disposed.

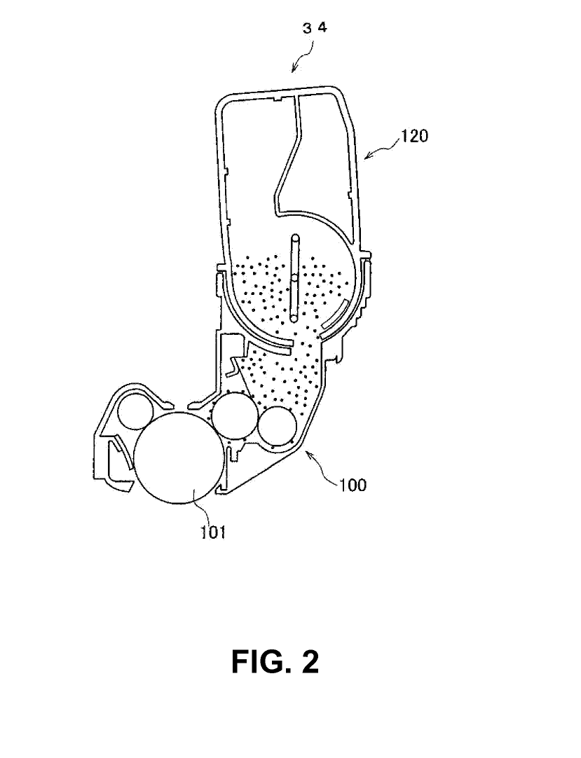

In the embodiment, the transfer portion 16 includes a transfer belt 17 for absorbing and transporting the medium 50 through an electrostatic force; a drive roller 18; a tension roller 19; transfer rollers 20 to 23; a transfer belt cleaning blade 24 for scraping off toner attached to the transfer belt 17 to clean a surface of the transfer belt 17; and a toner box 25 for collecting toner scraped off with the transfer belt cleaning blade 24. The drive roller 18 is configured to receive a rotational force from, for example, a drive source, so that the drive roller 18 drives the transfer belt 17. The tension roller 19 is arranged to be paired with the drive roller 18, so that the driver roller 18 and the tension roller 19 extend the transfer belt 17. In the developing devices 31, 32, 33, and 34, the transfer rollers 20 to 23 are arranged to face and abut against photosensitive drums 101 (refer to FIG. 2), so that the transfer rollers 20 to 23 apply a voltage to transfer the toner images to the medium 50.

### Configuration of Developing Device

FIG. 2 is a schematic sectional view showing an internal configuration of the developing device 34 of the image forming apparatus 10 according to the embodiment of the present invention. It should be noted that the internal configuration of the developing device 34 using toner in transparent (CL) is shown in FIG. 2 as a representative of the developing devices 31, 32, 33, and 34.

As shown in FIG. 2, the developing device 34 includes a developing portion 100 and a toner cartridge 120 as a developer container unit. The developing device 34 is configured to be freely attached to and detached from the image forming apparatus 10 (refer to FIG. 1), and the toner cartridge 120 is configured to be freely attached to and detached from the developing portion 100.

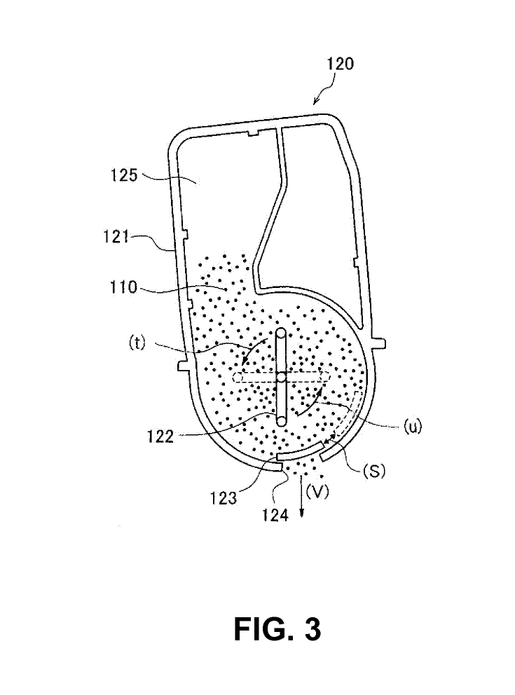

FIG. 3 is a schematic sectional view showing an internal configuration of the toner cartridge 120 of the developing device 34 of the image forming apparatus 10 according to the embodiment of the present invention.

As shown in FIG. 3, the toner cartridge 120 includes a container main body 121; a toner container portion 125; a stirring bar 122; a shutter 123; and a discharge opening 124 each disposed in the container main body 121. The toner cartridge 120 is configured to be freely attached to and detached from the image forming apparatus 10, and is formed in a shape elongated in a longitudinal direction corresponding to a direction perpendicular to a sheet surface of FIG. 3.

In the embodiment, the toner container portion 125 includes a container portion divided inside the container main body 121, so that electrostatic charge developing toner (described later) is retained in the container portion. The electrostatic charge developing toner is formed of a toner base particle and an outer additive agent attached to the toner base particle. The toner base particle is produced with a solution emulsion method. The outer additive agent contains 1.0 to 1.5 wt % of a composite oxide particle containing titanium dioxide and silicon dioxide, and 0.2 to 0.3 wt % of a melamine resin particle.

In the embodiment, the stirring bar 122 is provided as an example of a stirring member for stirring toner 110 retained inside the toner container portion 125, so that the toner 110 inside the toner container portion 125 is not solidified or eccentrically located. Further, the stirring bar 122 is disposed to extend in the longitudinal direction of the toner cartridge 120 at a specific position inside the toner container portion 125, and is supported to be freely rotatable. More specifically, the stirring bar 122 is supported to be rotatable in an arrow direction (t) and an arrow direction (u) in FIG. 3.

In the embodiment, the discharge opening 124 is formed at a lower portion of the container main body 121, and is provided as an opening portion for discharging the toner 110 toward the developing portion 100. The shutter 123 is provided as an opening and closing member of the discharge opening 124, and is arranged to be slidable in an arrow direction (s), so that the shutter 123 opens and closes the opening portion of the discharge opening 124.

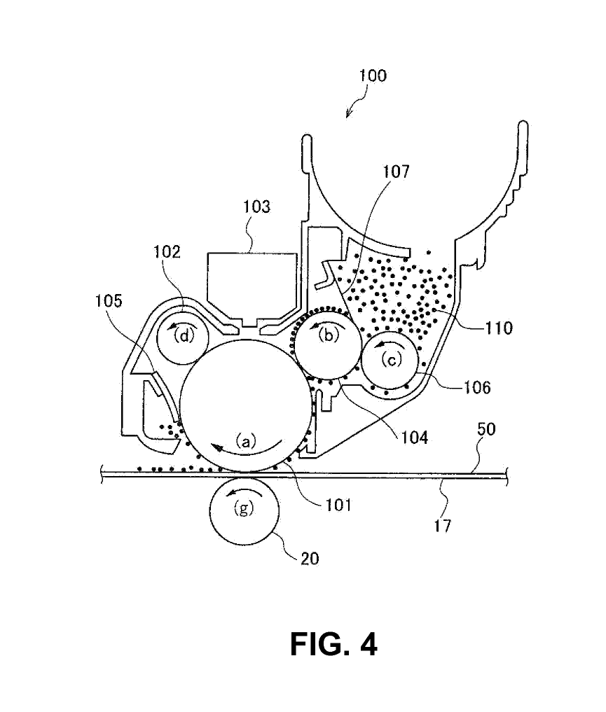

FIG. 4 is a schematic sectional view showing an internal configuration of the developing portion 100 of the developing device 34 of the image forming apparatus 10 according to the embodiment of the present invention.

As shown in FIG. 4, the developing portion 100 includes the photosensitive drum 101; a charging roller 102; an LED (Light Emitting Diode) head 103; a developing roller 104; a supplying roller 106; a developing blade 107; and a cleaning blade 105.

In the embodiment, the photosensitive drum 101 is provided as an example of a developer supporting member for forming the toner image (a developer image) through attaching the developing portion 100 supplied from the supplying roller 106 to a static latent image formed with the LED head 103. After the toner image is formed, the photosensitive drum 101 transfers the toner image to the medium 50 on the transfer belt 17 between the photosensitive drum 101 and the transfer roller 20. Further, the photosensitive drum 101 is formed of, for example, a conductive supporting member and a photo conductive layer. More specifically, the photosensitive drum 101 is an organic type photosensitive member formed of a metal pipe made of aluminum as the conductive supporting member, and an electric charge generation layer and an electric charge transportation layer as the photo conductive layer laminated on the metal pipe.

In the embodiment, the charging roller 102 is one of components of a charging device. The charging roller 102 is disposed to contact with a circumferential surface of the photosensitive drum 101, so that the charging roller 102 charges the surface of the photosensitive drum 101. Further, the charging roller 102 is formed of a metal shaft and a semi-conductive epichlorohydrin rubber layer.

In the embodiment, the LED head 103 is an example of an exposure device for exposing the photosensitive drum 101. Further, the LED head 103 is formed of, for example, an LED element and a lens array, so that illumination light emitted from the LED element forms an image on the surface of the photosensitive drum 101.

In the embodiment, the developing roller 104 is an example of a developer supporting member, and is provided for supporting the toner 110 supplied from the supplying roller 106 and transporting the toner 110 to the static latent image on the surface of the toner 110. Further, the developing roller 104 is formed of, for example, a metal shaft and a semi-conductive urethane rubber layer.

In the embodiment, the supplying roller 106 is an example of a developer supplying member, and is provided for supplying the toner 110 as developer to the developing roller 104 that slides against the supplying roller 106. Further, the supplying roller 106 is formed of, for example, a metal shaft and a semi-conductive foamed silicone sponge layer.

In the embodiment, the toner 110 as developer is produced with the solution emulsion method using a polyester resin as a binder resin. Further, the toner 110 contains a polyester resin and a mold release agent. Further, as described later, the toner 110 contains a composite oxide particle and a melamine resin particle as an outer additive agent through an outer addition step performed on a surface of the toner 110. Accordingly, it is possible to improve flow ability and durability of the toner 110, and to maintain an environmental stability and a control bias responsiveness relative to the developing roller 104.

In the embodiment, the developing blade 107 is an example of a developer regulating member, and is provided for regulating a thickness of a layer of the toner 110 on the surface of the supplying roller 106. A distal end portion of the developing blade 107 is arranged to be away from the supplying roller 106 by a specific distance. Further, the developing blade 107 may be formed of a metal blade made of stainless steel and the like.

In the embodiment, the cleaning blade 105 is an example of a developer collecting member. The cleaning blade 105 is arranged to be pressed against the surface of the photosensitive drum 101. After the toner image is transferred, the cleaning blade 105 collects the toner 110 remaining on the surface of the photosensitive drum 101. Further, the cleaning blade 105 may be formed of, for example, a urethane rubber member.

In the embodiment, after the toner image in each color is transferred to the medium 50 at the image forming portion 30 shown in FIG. 1, the medium 50 is transported in an arrow direction (h) to the fixing portion 40. The fixing portion 40 is configured to apply heat and pressure to the medium 50, so that the toner images on the medium 50 are fixed.

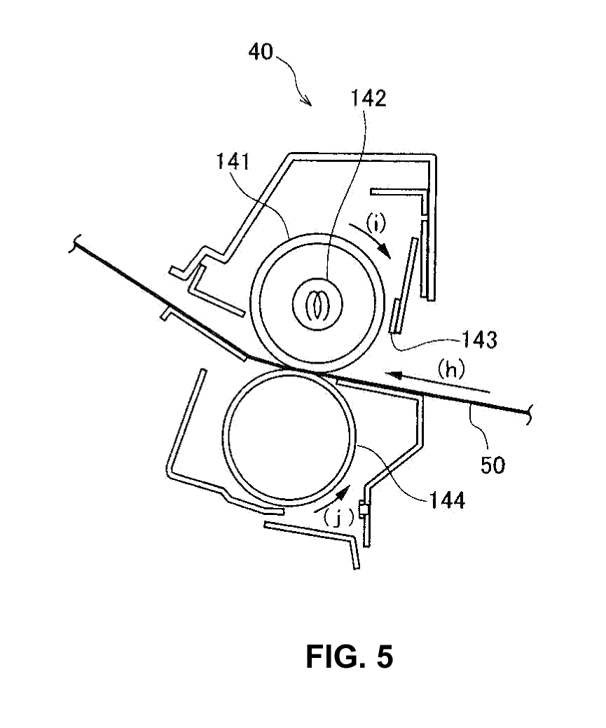

FIG. 5 is a schematic sectional view showing an internal configuration of the fixing portion 40 of the image forming apparatus 10 according to the embodiment of the present invention.

As shown in FIG. 5, the fixing portion 40 includes a heating roller 141; a pressing roller 144; a thermistor 143; and a heating heater 142.

In the embodiment, the heating roller 141 is formed of, for example, a core metal having a hollow cylindrical column shape and mage of aluminum and the like. A heat resistant elastic layer made of a silicone rubber covers the core metal. Further, a PFA (tetrafluoroethylene perfluoro-alkylvinylether copolymer) tube is formed over the heat resistant elastic layer. The heating heater 142 (formed of a halogen lamp in the embodiment) is disposed inside the core metal of the heating roller 141.

In the embodiment, the pressing roller 144 is formed of, for example, a core metal made of aluminum and the like; a heat resistant elastic layer made of a silicon rubber and covering the core metal; and a PFA tube disposed over the heat resistant elastic layer. Further, the pressing roller 144 is arranged to form a pressing portion between the pressing roller 144 and the heating roller 141.

In the embodiment, the thermistor 143 is provided for detecting a surface temperature of the heating roller 141. The thermistor 143 is disposed near the heating roller 141 in a non-contact state. When the thermistor 143 detects temperature information, the temperature information is transmitted to a temperature control unit of the image forming apparatus 10, for example, thereby controlling a temperature. Accordingly, it is possible to control on and off of the heating roller 142 according to the temperature information detected with the thermistor 143, thereby making it possible to maintain the surface temperature of the heating roller 141 at a specific temperature.

### Image Forming Process

An image forming process of the image forming apparatus 10 in the embodiment will be explained next. First, a developing process of the image forming process will be explained.

As shown in FIG. 4, the photosensitive drum 101 is driven by, for example, a drive unit such as a motor to rotate in an arrow direction (a) at a constant circumferential speed. The charging roller 102 is arranged to contact with the surface of the photosensitive drum 101. While the charging roller 102 is rotating in an arrow direction (d), the charging roller 102 applies a direct current voltage supplied from, for example, a charging roller high voltage power source to the surface of the photosensitive drum 101, so that the surface of the photosensitive drum 101 is uniformly charged.

In the next step, the LED head 103 arranged to face the photosensitive drum 101 irradiates light corresponding to an image signal to the surface of the photosensitive drum 101 that is uniformly charged, so that the static latent image is formed through optically decaying a potential of an irradiated area.

When the toner cartridge 120 shown in FIG. 3 is attached to the developing portion 100 shown in FIG. 2, the shutter 123 is slid in an opening direction through, for example, a lever operation and the like, thereby forming the opening portion. Accordingly, the toner 110 in the toner container portion 125 is dropped through the discharge opening 124 in an arrow direction (v) in FIG. 3, so that the toner 110 is supplied to the developing portion 100.

In the embodiment, a supplying roller high voltage power source, for example, applies a voltage to the supplying roller 106 shown in FIG. 4. When the supplying roller 106 is rotated in an arrow direction (c), the toner 110 is supplied to the developing roller 104.

In the embodiment, the developing roller 104 is arranged to closely contact with the photosensitive drum 101, and a developing roller high voltage power source, for example, applies a voltage to the developing roller 104. When the toner 110 is supplied to the developing roller 104, the developing roller 104 absorbs the toner 110 and is rotated in an arrow direction (d) to transport the toner 110. It should be noted that the developing blade 107 is arranged on a downstream side of the supplying roller 106 to be pressed against the developing roller 104. Accordingly, the developing blade 107 forms a toner layer with a uniform thickness of the toner 110 absorbed to the developing roller 104.

Further, in the embodiment, the developing roller 104 is configured to invert and develop the static latent image formed on the photosensitive drum 101 using the toner 110 supported on the developing roller 104 through the following process. A high voltage power source applies a bias voltage between the conductive supporting member of the photosensitive drum 101 and the developing roller 104. Accordingly, an electric force line is generated between the developing roller 104 and the photosensitive drum 101 according to the static latent image formed on the photosensitive drum 101. As a result, the toner 110 charged on the developing roller 104 is attached to a portion corresponding to the static latent image on the photosensitive drum 101 through the static electric force, so that the portion corresponding to the static latent image is developed to form the toner image. It should be noted that the developing process described above starts at a specific timing when the photosensitive drum 101 starts rotating.

As shown in FIG. 1, the medium 50 is retained in the medium retaining cassette 11. As described above, the medium transportation rollers 45a and 45b are provided for picking up and transporting the medium 50 retained in the medium retaining cassette 11 one by one from in the arrow direction (l).

Afterward, the medium transportation rollers 45c and 45d and the medium transportation rollers 45e and 45f transport the medium 50 in the arrow direction (e). At this time, the medium 50 is transported along a transportation guide, so that the medium 50 is being transported while correcting the skew thereof. Further, the drive roller 18 is rotated in the arrow direction (g) to rotate the transfer belt 17 in the arrow direction (f), and the medium 50 is transported to the transfer belt 17. It should be noted that the developing process described above starts at the specific timing while the medium 50 is being transported in the arrow direction (e).

In the next step, a transfer process is performed as shown in FIG. 4. The transfer roller 20 is arranged to face the photosensitive drum 101 of the developing device 31 with the transfer belt 17 in between in the pressing state. Further, a transfer roller high voltage power source, for example, applies a voltage to the transfer roller 20.

In the embodiment, the medium 50 is statically attracted to the transfer belt 17 to be transported. Further, the transfer roller 20 transfers the toner image in yellow formed on the surface of the photosensitive drum 101 through the developing process described above to the medium 50.

In the embodiment, the medium 50 is transported on the transfer belt 17 in the arrow direction (f) shown in FIG. 1. Accordingly, the developing process and the transfer process are sequentially performed in an order of yellow, magenta, cyan, and transparent. More specifically, the developing device 31 and the transfer roller 20 transfers the toner image in yellow to the medium 50; the developing device 32 and the transfer roller 21 transfers the toner image in magenta to the medium 50; the developing device 33 and the transfer roller 22 transfers the toner image in cyan to the medium 50; and the developing device 34 and the transfer roller 23 transfers the toner image in yellow to the medium 50. After the toner images in each color are transferred to the medium 50, the medium 50 is transported in the arrow direction (h).

A fixing process will be explained next. As shown in FIG. 5, after the toner images in colors are transferred to the medium 50, the medium 50 is transported in the arrow direction (h), so that the medium 50 is transported into the fixing portion 40 having the heating roller 141 and the pressing roller 144.

As described above, the temperature control unit, for example, controls the surface temperature of the heating roller 141 of the fixing portion 40 at the specific level. After the toner images are transferred to the medium 50, the medium 50 is transported between the heating roller 141 rotating in an arrow direction (1) and the pressing roller 144 rotating in an arrow direction (j). As a result, the heating roller 141 applies heat to the medium 50, so that the toner images on the medium 50 are melted. Further, the toner images thus melted on the medium 50 are pressed at the pressing portion between the heating roller 141 and the pressing roller 144, thereby fixing the toner images to the medium 50.

After the toner images are fixed to the medium 50, the medium transportation rollers 45g and 45h and the medium transportation rollers 45i and 45j transport the medium 50 in an arrow direction (k), so that the medium 50 is discharged to a stacker portion 46 disposed outside the image forming apparatus 10.

A cleaning process will be explained next. As shown in FIG. 4, even after the toner images are transferred, a small amount of the toner 110 may remain on the surface of the photosensitive drum 101. The cleaning blade 105 is provided for removing the photosensitive drum 101 remaining on the surface of the photosensitive drum 101.

In the embodiment, the cleaning blade 105 is arranged in parallel to a rotational axis direction of the photosensitive drum 101 extending in the longitudinal direction (the direction perpendicular to the sheet surface of FIG. 4). Further, the cleaning blade 105 is arranged such that the distal end portion thereof abuts against the surface of the photosensitive drum 101 and the base portion thereof is attached and fixed to a rigid supporting board.

In the embodiment, when the photosensitive drum 101 is rotated around the rotational axis thereof in the state that the distal end portion of the cleaning blade 105 contacts with the circumferential surface of the photosensitive drum 101, the cleaning blade 105 removes the photosensitive drum 101 remaining on the surface of the photosensitive drum 101. Through the process described above, it is possible to reuse the photosensitive drum 101 thus removed.

In the image forming apparatus 10 shown in FIG. 1, the toner 110 may not be insufficiently charged between sheets when the image forming apparatus 10 performs a continuous printing operation. In this case, the toner 110 insufficiently charged may be transferred from the photosensitive drum 101 of each of the developing devices 31 to 34 to the transfer belt 17. Even in this case, when the transfer belt 17 is rotated and moved in the arrow direction (f) and the arrow direction (r), the transfer belt cleaning blade 24 removes the toner 110 from the transfer belt 17, so that the toner 110 is collected in the toner box 25 as insufficiently charged toner. Through the cleaning process described above, the transfer belt 17 is cleaned and used repeatedly.

In the embodiment, the medium transportation rollers 45k to 45x and the transportation path switching guides 41 and 42 are provided for transporting and guiding the medium 50 in a specific transportation direction when the image forming apparatus 10 performs a duplex printing operation. It should be noted that detailed explanations thereof are omitted.

### Electrostatic Charge Developing Toner

The electrostatic charge developing toner according to the embodiment will be explained next with reference to the accompanying drawings.

As described above, in the embodiment, the electrostatic charge developing toner contains the toner base particle produced with a solution emulsion method. More specifically, the electrostatic charge developing toner contains the toner base particle produced through the following steps. First, a binder resin (a tacking resin) and an additive are solved and dispersed in an organic solvent to obtain an oily phase. An inorganic fine particle is dispersed in an aqueous solvent to obtain an aqueous phase. Then, the oily phase and the aqueous phase are mixed and suspended, so that the inorganic fine particle is attached to a surface of an oily phase liquid droplet to obtain such an oily phase liquid droplet. After the oily phase liquid droplet is obtained, the solvent is removed. Then, an acid is added and the inorganic fine particle is removed, thereby producing the toner base particle.

### Binder Resin

In the embodiment, the binder resin is a single monomer-unit polymer formed of monomers. The monomer may include a styrene type monomer such as styrene, parachloro-styrene, α-methyl styrene, and the like; an ester type monomer containing a vinyl group such as methyl acrylate, ethyl acrylate, n-propyl acrylate, n-butyl acrylate, lauryl acrylate, 2-ethyl-hexyl acrylate, methyl methacrylate, ethyl methacrylate, n-propyl methacrylate, n-butyl methacrylate, lauryl acrylate, 2-ethyl-hexyl methacrylate, and the like; a vinyl nitrile type monomer such as acrylic nitrile, methacrylic nitrile, and the like; a vinyl ether type monomer such as vinyl methyl ether, vinyl isobutyl ether, and the like; a vinyl ketone type monomer such as vinyl methyl ketone, vinyl ethyl ketone, vinyl isopropyl ketone, and the like; and a polyolefin type monomer such as ethylene, propylene, butadiene, and the like.

In the embodiment, the binder resin may be a copolymer obtained through combining more than two types of the monomers, or a mixture thereof. Further, the binder resin may be an epoxy resin, a polyester resin, a polyurethane resin, a polyamide resin, a cellulose resin, a polyether resin, a non-vinyl condensation resin, a mixture thereof with the vinyl resin, and a graft copolymer obtained through polymerizing a vinyl type monomer with the presence of the resins described above.

In the embodiment, a polyester resin is used as an example of the binder resin. In order to enhance hydrophobic property thereof, the polyester resin as the binder resin is modified with a long-chain alkyl group having a chemical structure represented with the formula (1) shown below:

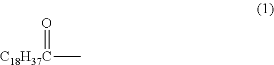

When the polyester resin modified with the long-chain alkyl group having the chemical structure represented with the formula (1) is produced, an alcohol component and a carbonic acid component are condensed and polymerized. Further, the transparent toner according to the embodiment may use a polyester obtained through condensing and polymerizing an alcohol component and a carbonic acid component.

In the embodiment, the alcohol component may include, for example, ethylene glycol, diethylene glycol, triethylene glycol, polyethylene glycol, propylene glycol, butane diol, pentane diol, hexane diol, cyclohexane dimethanol, xylene glycol, dipropylene glycol, polypropylene glycol, bisphenol A, hydrogenated bisphenol A, bisphenol A ethylene oxide, bisphenol A propylene oxide, sorbitol, more than divalent alcohol such as glycerin, an alcohol derivative, and the like.

In the embodiment, the carbonic acid component may include, for example, maleic acid, fumaric acid, phthalic acid, isophthalic acid, telephthalic acid, succinic acid, adipic acid, trimellitic acid, trimellitic anhydride, maleic anhydride, more than divalent carbonic acid such as dodecenyl succinic anhydride, a carbonic acid derivative, and the like.

It should be noted that more than two types of the alcohol component and the carbonic acid component may be combined.

### Organic Solvent

In the embodiment, an ordinary organic solvent may be used as the organic solvent for producing the oily phase. The organic solvent may include, for example, an ester type such as methyl acetate, ethyl acetate, butyl acetate, and the like. Further, the organic solvent may include, for example, a hydrocarbon such as toluene, xylene, and the like; a holgeneted hydrocarbon such as methylene chloride, chloroform, dichloroethane, and the like; an alcohol such as ethanol, methanol, and the like; a ketone such as acetone, methylethylketone, cyclohexanone, and the like. It should be noted that more than two type of the organic solvent may be mixed and used.

In the embodiment, ethyl acetate is used as an example of the organic solvent. As described above, in the solution emulsion method, after the oily phase is poured and suspended in the aqueous phase to obtain the oily phase liquid droplet, the oily phase is selectively evaporated to remove the organic solvent. Accordingly, it is preferred to use the organic solvent having a boiling point lower than water that is the solvent of the aqueous phase, and further having relatively low solubility relative to water. Therefore, in the embodiment, ethyl acetate is used as an example of the organic solvent.

### Mold Release Agent

In the embodiment, a mold release agent may be added to improve fixing property and offset durability of the transparent toner. The mold release agent may include, for example, a petrolium wax such as paraffin wax, oxidized paraffin wax, and the like; a synthesized wax such as oxidized polyolefin wax and the like; an ester wax; an ether wax; a wax produced from an animal or a vegetable; and the like.

In the embodiment, paraffin wax is used as the mold release agent. As described above, ethyl acetate is used as an example of the organic solvent. Accordingly, ester wax may be used since ester wax is relatively easily soluble in ethyl acetate and improves hydrophobic property of the polyester resin as the binder resin. However, ester wax tends to have a larger average molecular weight relative to paraffin wax, thereby increasing a viscosity upon being melted. As a result, when ester wax is used as the mold release agent of the transparent toner, it may be difficult to obtain a uniform text, thereby making an image blurry. For the reason, in the embodiment, paraffin wax, which has a smaller average molecular weight than paraffin wax and a lower viscosity upon being melted, is used as the mold release agent.

### Aqueous Solvent

In the embodiment, water is mainly used as the aqueous solvent for forming the aqueous phase. It should be noted that a mixture of water and a water soluble solvent may be used as the aqueous solvent.

### Dispersion Agent

An inorganic fine particle may be used as a suspension stabilizing agent as the dispersion agent. The suspension stabilizing agent may include, for example, tricalcium phosphate, hydroxy apatite, calcium carbonate, titanium oxide, aluminum hydroxide, magnesium hydrate, magnesium hydrate, silica, and the like.

### Outer Additive Agent

In the embodiment, the transparent toner is used for acquiring gloss, being attached to colored toner, and being attached to a recording medium such as a sheet and the like. Accordingly, the transparent toner is formulated such that the colored toner visibly stands out when the transparent toner is attached to the colored toner, or the recording medium can be visibly confirmed when the transparent toner is attached to the recording medium. When the transparent toner is produced, a fluorescent brightening agent may be added without adding a colorant agent.

In the embodiment, the toner base particle contains the outer additive agent for improving the flow property of the toner and image quality.

In the embodiment, the outer additive agent may include an inorganic fine particle such as colloidal silica, silicon dioxide, titanium dioxide, aluminum oxide, a composite oxide, and the like; and a melamine resin particle. It should be noted that the outer additive agent may be a mixture of various types of inorganic fine particle.

In the embodiment, the outer additive agent includes a composite particle containing silicon dioxide and titanium dioxide, the melamine resin particle, colloidal silica, and two type of silicon dioxide with average primary particles having different particle diameters (in the following description, referred to as silica A and silica B).

In the embodiment, relative to the toner base particle, the composite particle containing silicon dioxide and titanium dioxide is contained between 1.0 wt % and 1.5 wt %; the melamine resin particle is contained between 0.2 wt % and 0.3 wt %; colloidal silica is contained at 0.1 wt %; silica A (with the average primary particle having the particle diameter of 80 nm) is contained at 1.0 wt %; and silica B (with the average primary particle having the particle diameter of 40 nm) is contained at 1.5 wt %.

In general, when an image forming apparatus performs a printing operation under a high temperature and high humidity condition, a printed image may be blurred. It is supposed that this is caused because under a high temperature and high humidity condition, toner tends to lose flow ability. When toner tends to lose flow ability, toner particles tend to collide with each other more often. As a result, the outer additive agent tends to be embedded and separated due to friction and the like, so that toner tends to be deteriorated. When toner is deteriorated, toner particles tend to be collagurated, thereby causing an agglomerated toner to stay at a specific location. As a result, it is difficult to smoothly transport and supply toner, thereby making an image blurry.

For example, when toner particles are collagurated, agglomerated toner may stay at the abutting portion of the developing roller 104 and the supplying roller 106, or both end portions of the developing roller 104. Further, agglomerated toner may enter into the sponge layer of the supplying roller 106, thereby clogging the sponge layer. When these phenomena occurs, an image forming apparatus tends to produce a blurred image.

To this end, in the embodiment, toner contains the composite oxide particle with a small particle diameter containing titanium dioxide and silicon dioxide and the melamine resin particle with a large particle diameter, so that it is possible to improve the flow ability and durability of toner. The melamine resin particle has a relatively large particle diameter and relatively high hardness. Accordingly, when the melamine resin particle as the outer additive agent is attached to the toner base particle, it is possible to prevent the toner base particle from colliding with each other. As a result, it is possible to prevent toner from being deteriorated due to separation of the outer additive agent.

On the other hand, the composite oxide particle containing titanium dioxide and silicon dioxide has a relatively small particle diameter. Accordingly, it is easy for the composite oxide particle to enter a space between the outer additive agent containing the melamine resin particle with a large particle diameter, so that the composite oxide particle is attached to the toner base particle. As a result, toner exhibits good flow ability, and it is possible to minimize the collaguration of the toner base particle. For example, it is possible to reduce an amount of agglomerated toner at the both end portions of the developing roller 104. For the reasons explained above, toner contains the composite oxide particle with a small particle diameter containing titanium dioxide and silicon dioxide and the melamine resin particle with a large particle diameter, thereby improving the flow ability and durability of toner.

Further, in order to prevent an image from being blurred and secure an image with high quality regardless of an environmental change, it is necessary to stably charge toner supplied from the cleaning blade 105 to the developing roller 104. Further, when an environment is changed, a difference in surface potential of the developing roller 104 and the cleaning blade 105 may change. In order to minimize a negative effect caused by the change in the difference in the surface potential of the developing roller 104 and the cleaning blade 105 due to the environmental change, the composite oxide particle containing titanium dioxide and silicon dioxide is mixed as the outer additive agent.

As described above, the composite oxide particle containing titanium dioxide and silicon dioxide has a small particle diameter. Further, titanium dioxide contained in the composite oxide particle is effective to stabilize the charging of toner, so that it is possible to secure a stable potential of toner. Accordingly, when the composite oxide particle is attached to the toner base particle, it is possible to improve the charging stability of toner and control bias responsiveness. It should be noted that a large amount of the composite oxide particle is attached to the toner base particle (for example, more than 1.5 wt %), the composite oxide particle of the composite oxide particle shows excessive effectiveness to stabilize the charging, so that the control bias responsiveness tends to be lowered.

As described above, in the embodiment, toner contains the composite oxide particle containing titanium dioxide and silicon dioxide, and the composition of the composite oxide particle is not limited thereto. For example, as long as the particle diameter of the composite oxide particle is about 10 and a few nm, the composite oxide particle may contain, for example, aluminum oxide and silicon dioxide, magnesium oxide and silicon dioxide, and the like

### Preparation of Electrostatic Charge Developing Toner

A process of preparing the transparent toner as the electrostatic charge developing toner according to the embodiment will be explained next. It should be noted that the process is not limited to the transparent toner, and may be applicable to the colored toner such as yellow (Y), magenta (M), cyan (C), black (K), and the like.

In the following description, several examples and comparative examples were prepared through the process of preparing the transparent toner as the electrostatic charge developing toner according to the embodiment. Then, the examples and the comparative examples were evaluated. In the evaluation, the printing operation was performed using the transparent toner under the high temperature and high humidity environment (referred to as HH) and the low temperature and low humidity environment (referred to as LL), and the blurred image was evaluated. Further, the toner layer potential on the developing roller 104 (referred to as an HH potential) and the toner layer potential on the developing roller 104 (referred to as an LL potential) were evaluated under the high temperature and high humidity environment and the low temperature and low humidity environment, respectively. Further, the control bias responsiveness was evaluated.

In the following description, it should be noted that the toner base particle of the transparent toner was prepared with the solution emulsion method according to the examples and the comparative examples.

As described above, the solution emulsion method includes (a) the aqueous phase preparation step; (b) the oily phase preparation step; (c) the particle preparation step; (d) the toner base particle preparation step; and (e) the outer additive agent addition step. In the aqueous phase preparation step, the dispersion agent (the inorganic dispersion agent) is dispersed in the aqueous solvent to obtain the aqueous phase. In the oily phase preparation step, the binder resin and the mold release agent are added in the organic solvent to obtain the oily phase. In the particle preparation step, the oily phase is poured into the aqueous phase to obtain the oily phase liquid droplet, and the organic solvent is removed from the oily phase liquid droplet to obtain the particle. In the toner base particle preparation step, after the particle in the liquid is dehydrated, the particle is washed with acid to dissolve the suspension stabilizing agent. Then, the particle is washed with acid one more time, and is dried to obtain the toner base particle. In the outer additive agent addition step, the outer additive agent is attached to the toner base particle.

### Example No. 1

### (a) The Aqueous Phase Preparation Step

In the step of preparing the aqueous phase with the inorganic dispersion agent dispersed therein, 11,024 weight parts of industrial grade trisodium 12 hydratedphosphate was mixed and dissolved in 329,676 weight parts of pure water at a liquid temperature of 60° C. to obtain a mixture. Then, dilute nitric acid was added to adjust a pH value of the mixture. In the next step, 5,319 weight parts of industrial grade calcium chloride anhydride was dissolved in 43,234 weight parts of pure water to obtain a calcium chloride solution, and the calcium chloride solution was poured into the mixture to obtain the aqueous phase. The aqueous phase was stirred at a high speed of 3,566 rotation/minute with Line Mill (a product of PRIMIX Corporation) for 50 minutes while maintaining a liquid temperature at 60° C., thereby preparing the aqueous phase containing the suspension stabilizing agent (the dispersion agent).

### (b) The Oily Phase Preparation Step

The step of preparing the oily phase containing the polyester resin having the chemical structure represented with the formula (1) will be explained next.

First, 76,565 weight parts of ethyl acetate as the organic solvent was heated and stirred at a liquid temperature of 50° C. Then, 1,068 weight parts of paraffin wax (SP-0145, melting point 62° C., a product of Nippon Seiro Co., Ltd.) and 28 weight parts of the fluorescent brightening agent were sequentially added to the organic solvent.

Secondly, 13,361 weight parts of the polyester resin was added to the organic solvent, and the organic solvent was stirred until a sold component disappeared to obtain the oily phase. The polyester resin has a glass transition temperature of 66° C. and a melting temperature (T_{1/2}) of 112° C. It should be noted that the melting temperature (T_{1/2}) indicates a softening point with a 1/2 method.

### (c) The Particle Preparation Step

The aqueous phase was maintained at the light temperature of 55° C., and the oily phase described above was dropped into the aqueous phase. The aqueous phase was stirred at a high speed of 2,000 rotation/minute with Line Mill (a product of PRIMIX Corporation) for 50 minutes to suspend the oily phase, thereby preparing the particle. Afterward, ethyl acetate was removed through vacuum evaporation.

### (d) The Toner Base Particle Preparation Step

After the particle in the liquid was dehydrated once, the particle thus dehydrated was dispersed in pure water one more time. Then, nitric acid was added to adjust the pH value below 1.5 and the liquid was stirred to perform acid washing. Then, tricalcium phosphate as the suspension stabilizing agent was dissolved, and the particle was dehydrated. Then, the particle thus dehydrated was dispersed and stirred in pure water one more time to perform water washing. Lastly, the particle was dehydrated and dried, thereby obtaining the toner base particle.

### (e) The Outer Additive Agent Addition Step

After the toner base particle was prepared, 953 weight parts of the toner base particle thus prepared was placed in Henschel mixer (a product of Mistui Mining Co., Ltd.). Then, the composite oxide particle containing titanium dioxide and silicon dioxide (STX801, the average primary particle 18 nm, a product of Nippon Aerosil Co., Ltd.); colloidal silica (X24-9163A, the average primary particle 110 nm, a product of Shin-Etsu Chemical Co., Ltd.); the melamine resin particle (EPOSTAR S, the average primary particle 210 nm, a product of Nippon Shokubai Co., Ltd.); silica A (VPRY40S, the average primary particle 80 nm, a product of Nippon Aerosil Co., Ltd.); and silica B (RY50, the average primary particle 40 nm, a product of Nippon Aerosil Co., Ltd.) were added and mixed to obtain toner a. The composite oxide particle was added at 1.0 wt % relative to the toner base particle; colloidal silica was added at 1.0 wt % relative to the toner base particle; the melamine resin particle was added at 0.2 wt % relative to the toner base particle; silica A was added at 1.0 wt % relative to the toner base particle; and silica B was added at 1.5 wt % relative to the toner base particle.

### Example No. 2

In the example No. 2, in the outer additive agent addition step, the composite oxide particle was added at 1.5 wt % relative to the toner base particle, thereby obtaining toner b. Other steps were the same as those in the example No. 1.

### Example No. 3

In the example No. 3, in the outer additive agent addition step, the melamine resin particle was added at 0.3 wt % relative to the toner base particle, thereby obtaining toner c. Other steps were the same as those in the example No. 1.

### Example No. 4

In the example No. 4, in the outer additive agent addition step, the composite oxide particle was added at 1.5 wt % relative to the toner base particle, and the melamine resin particle was added at 0.3 wt % relative to the toner base particle, thereby obtaining toner d. Other steps were the same as those in the example No. 1.

### Comparative Example No. 1

In the comparative example No. 1, in the outer additive agent addition step, the composite oxide particle was added at 2.0 wt % relative to the toner base particle, and the melamine resin particle was added at 0.2 wt % relative to the toner base particle, thereby obtaining toner e. Other steps were the same as those in the example No. 1.

### Comparative Example No. 2

In the comparative example No. 2, in the outer additive agent addition step, the composite oxide particle was added at 2.0 wt % relative to the toner base particle, and the melamine resin particle was added at 0.3 wt % relative to the toner base particle, thereby obtaining toner f. Other steps were the same as those in the example No. 1.

### Comparative Example No. 3

In the comparative example No. 3, in the outer additive agent addition step, the composite oxide particle was added at 1.0 wt % relative to the toner base particle, and the melamine resin particle was added at 0.4 wt % relative to the toner base particle, thereby obtaining toner g. Other steps were the same as those in the example No. 1.

### Comparative Example No. 4

In the comparative example No. 4, in the outer additive agent addition step, the composite oxide particle was added at 1.5 wt % relative to the toner base particle, and the melamine resin particle was added at 0.4 wt % relative to the toner base particle, thereby obtaining toner h. Other steps were the same as those in the example No. 1.

### Comparative Example No. 5

In the comparative example No. 5, in the outer additive agent addition step, the composite oxide particle was added at 1.0 wt % relative to the toner base particle, and the melamine resin particle was added at 0.1 wt % relative to the toner base particle, thereby obtaining toner i. Other steps were the same as those in the example No. 1.

### Comparative Example No. 6

In the comparative example No. 6, in the outer additive agent addition step, the composite oxide particle was added at 1.5 wt % relative to the toner base particle, and the melamine resin particle was added at 0.1 wt % relative to the toner base particle, thereby obtaining toner j. Other steps were the same as those in the example No. 1.

### Comparative Example No. 7

In the comparative example No. 7, in the outer additive agent addition step, the composite oxide particle was added at 0.5 wt % relative to the toner base particle, and the melamine resin particle was added at 0.2 wt % relative to the toner base particle, thereby obtaining toner k. Other steps were the same as those in the example No. 1.

### Comparative Example No. 8

In the comparative example No. 8, in the outer additive agent addition step, the composite oxide particle was added at 0.5 wt % relative to the toner base particle, and the melamine resin particle was added at 0.3 wt % relative to the toner base particle, thereby obtaining toner 1. Other steps were the same as those in the example No. 1.

### Comparative Example No. 9

In the comparative example No. 9, in the outer additive agent addition step, the composite oxide particle was added at 2.5 wt % relative to the toner base particle, and the melamine resin particle was added at 0.2 wt % relative to the toner base particle, thereby obtaining toner m. Other steps were the same as those in the example No. 1.

### Comparative Example No. 10

In the comparative example No. 10, in the outer additive agent addition step, the composite oxide particle was added at 0.0 wt % relative to the toner base particle, and the melamine resin particle was added at 0.0 wt % relative to the toner base particle, thereby obtaining toner n. Other steps were the same as those in the example No. 1.

### Continuous Printing Evaluation

In the evaluation, the continuous printing was performed under the condition in which the bias was controlled so that the transparent toner was attached to the photosensitive drum 101 in the amount between 0.4 mg/cm² and 0.5 mg/cm². In the continuous printing, a lateral strip image with 100% was continuously printed on 3,000 sheets with 5% duty (A4 size sheet, lateral feeding, 20 ppm). After the continuous printing is performed, the blurred image and the toner layer potential on the developing roller 104 (the HH potential and the LL potential) were evaluated.

It should be noted that the high temperature and high humidity environment (HH) was defined as an environment where the temperature 20° C. is and the humidity is 80%, and the low temperature and low humidity environment (LL) was defined as an environment where the temperature 10° C. is and the humidity is 20%.

### Blurred Image Evaluation

As described above, the blurred image tends to occur more often under the high temperature and high humidity environment than the low temperature and low humidity environment. Accordingly, when the blurred image was evaluated, 3,000 sheets were continuously printed according to the method as described above, and it was visually determined whether the blurred image occurred or the extent of the blurred image on the 3,000-th sheet. When it was determined that the blurred image did not occur, the evaluation result represented with “good”. When it was determined that the blurred image occurred, the evaluation result was represented with “poor”.

In the evaluation, in addition to the blurred image, it was visually determined whether a lateral streak occurred on the printed sheet. As described above, as the main cause of the blurred image, it is supposed that when toner loses flow ability or durability of toner is deteriorated, toner particles tend to be collagurated, thereby causing an agglomerated toner to stay at a specific location such as the developing roller 104 and the supplying roller 106. If the agglomerated toner is the main cause of the blurred image, when toner particles are collagurated further, the extent of the blurred image should be aggregated, and the lateral steak should be generated. In the evaluation, in order to confirm that the agglomerated toner is the main cause of the blurred image, it was visually determined whether the lateral streak occurred as well.

### Potential Measurement

After 3,000 sheets were continuously printed according to the method as described above under the high temperature and high humidity environment (HH) and the low temperature and low humidity environment (LL), the potential of the transparent toner layer on the developing roller 104 was measured. In the potential measurement, after the printing operation was interrupted during printing a blank sheet, the potential of the transparent toner layer on the developing roller 104 was measured.

In the evaluation, the potential of the transparent toner layer on the developing roller 104 was measured after 3,000 sheets were continuously printed under the high temperature and high humidity environment (HH). When the potential was greater than 30 V, the evaluation result was represented with “good”. When the potential was smaller than 30 V, the evaluation result was represented with “poor”. Further, the potential of the transparent toner layer on the developing roller 104 was measured after 3,000 sheets were continuously printed under the low temperature and low humidity environment (LL). When the potential was smaller than 67 V, the evaluation result was represented with “good”. When the potential was greater than 67 V, the evaluation result was represented with “poor”.

In general, an image forming apparatus is used under various environmental conditions while using the transparent toner as well as other various types of toner. Even if an image forming apparatus is used under various environmental conditions, it is necessary to form an image with consistent quality. Accordingly, it is imperative for the transparent toner to stably achieve the charging stability according to an environmental condition.

Under the high temperature and high humidity environment (HH), when the potential of the layer of the transparent toner on the developing roller 104 is too low, the transparent toner tends to easily be fogged. On the other hand, under the low temperature and low humidity environment (LL), when the potential of the layer of the transparent toner on the developing roller 104 is too high, the transparent toner tends to easily be smeared. When the transparent toner is fogged or smeared, image quality of the printed image tends to be lowered. Accordingly, even in the environmental change such as the high temperature and high humidity environment (HH) and the low temperature and low humidity environment (LL), in order to form the image with high quality, it is critical for the transparent toner to secure the stable charging property. In the evaluation, the optimal range of the potential was set differently under the high temperature and high humidity environment (HH) and the low temperature and low humidity environment (LL).

### Control Bias Responsiveness Evaluation

In evaluating the control bias responsiveness, after the printing operation was interrupted during printing a blank sheet under an environment in which the temperature was 25° C. and the humidity was 50%, the attaching toner amount on the developing roller 104 was measured. More specifically, the voltage value (the developing bias value: DB) applied to the developing roller 104 was fixed to a specific value (for example, −145 V), and the voltage value (the sponge bias value: SB) applied to the cleaning blade 105 was changed, for example, from −180 V to −340V. Then, the change in the attaching amount of the transparent toner on the developing roller 104 before and after the sponge bias value was changed was measured. In the evaluation, when the increment of the attaching amount was greater than 0.05 mg/cm², the evaluation result was represented with “good”, and when the increment of the attaching amount was smaller than 0.05 mg/cm², the evaluation result was represented with “poor”.

In general, the control bias responsiveness is a property indicating whether the toner is stably attached to the developing roller 104 even when the surface potential difference between the developing roller 104 and the cleaning blade 105 is varied. When the control bias responsiveness of the transparent toner is high, it is possible to control the toner attaching amount at a sufficient level for securing good image quality according to not only the environmental change but also a variance of the components of the developing portion 100. In short, the control bias responsiveness is high, it is possible to control the image quality through a process control. Accordingly, it is possible to alleviate a tolerance range in the variance of the components of the developing portion 100 or the environmental change, thereby making the apparatus design more forgiving. To this end, the control bias responsiveness was evaluated.

Table shows the evaluation results of the examples No. 1 to No. 4 and the comparative examples No. 1 to No. 10.

| | | | | Continuous | | | | |
|---|---|---|---|---|---|---|---|---|
| | | | | Printing | | | | |
| | | A | B | Evaluation | | | | |
| Example | Toner | (wt %) | (wt %) | C | D | E | F | G |
| No. 1 | a | 1.0 | 0.2 | good | good | good | good | good |
| No. 2 | b | 1.5 | 0.2 | good | good | good | good | good |
| No. 3 | c | 1.0 | 0.3 | good | good | good | good | good |
| No. 4 | d | 1.5 | 0.3 | good | good | good | good | good |
| Comparative | | | | | | | | |
| example | | | | | | | | |
| No. 1 | e | 2.0 | 0.2 | good | good | good | poor | poor |
| No. 2 | f | 2.0 | 0.3 | good | good | good | poor | poor |
| No. 3 | g | 1.0 | 0.4 | good | good | poor | good | poor |
| No. 4 | h | 1.5 | 0.4 | good | good | poor | good | poor |
| No. 5 | i | 1.0 | 0.1 | poor | good | good | good | poor |
| No. 6 | j | 1.5 | 0.1 | poor | poor | good | good | poor |
| No. 7 | k | 0.5 | 0.2 | good | good | poor | good | poor |
| No. 8 | 1 | 0.5 | 0.3 | poor | good | poor | good | poor |
| No. 9 | m | 2.5 | 0.2 | good | poor | good | poor | poor |
| No. 10 | n | 0.0 | 0.0 | poor | poor | good | good | poor |

In Table, A represents the amount of the composite oxide particle; B represents the amount of the melamine resin particle; C represents the evaluation result of the blurred image; D represents the evaluation result of the HH potential; E represents the evaluation result of the LL potential; F represents the evaluation result of the control bias responsiveness; and G represent the overall evaluation result.

As shown in Table, when the continuous printing operation was performed using the transparent toner in the comparative examples No. 5, No. 6, No. 8, and No. 10, the blurred image occurred on the 3,000-th printed sheet. It was found that the amount of the transparent toner attached to the photosensitive drum 101 was less than 0.30 mg/cm² when the blurred image occurred. Further, it was confirmed that the lateral streak was generated when the blurred image occurred and the extent of the blurred image worsened. From the observation, it is supposed that the agglomeration of the transparent toner is one of causes of the blurred image. It should be noted that the amount of the transparent toner attached to the photosensitive drum 101 was less than 0.25 mg/cm² when the lateral streak was generated.

Further, according to the evaluation results of the comparative examples No. 1, No. 2, and No. 9, it was confirmed that, due to the good flow ability of the transparent toner thanks to silicon dioxide contained in the composite oxide particle, the blurred image did not occur when the transparent toner contained greater than 1.5 wt % of the composite oxide particle containing titanium dioxide and silicon dioxide. However, when the transparent toner contained greater than 1.5 wt % of the composite oxide particle, titanium dioxide contained in the composite oxide particle exhibited excessive charging effect. As a result, the control bias responsiveness became relatively low.

On the other hand, in the comparative examples No. 7 and No. 8, titanium dioxide contained in the composite oxide particle exhibited proper charging effect, so that the control bias responsiveness became relatively high.

More specifically, in the comparative example No. 7, the composite oxide particle exhibited the effect of improving the flow ability, the blurred image did not occur. However, in the comparative example No. 7, the transparent toner contained less than 1.0 wet % of the composite oxide particle. Accordingly, it is supposed that the effect of the melamine resin particle became prominent due to the ratio relative to the melamine particle. More specifically, the melamine resin particle exhibited the effect of increasing charge. As a result, the potential of the toner layer on the developing roller 104 (the LL potential) under the low temperature and low humidity environment (LL) increased.

Similarly, in the comparative example No. 8, the transparent toner contained less than 1.0 wet % of the composite oxide particle relative to the toner base particle. Accordingly, it is supposed that the effect of the melamine resin particle, that is larger and harder, became prominent due to the ratio relative to the melamine particle. More specifically, the melamine resin particle exhibited the effect of lowering the flow ability. As a result, the blurred image did occur. Further, the melamine resin particle exhibited the effect of increasing charge. As a result, the potential of the toner layer on the developing roller 104 (the LL potential) under the low temperature and low humidity environment (LL) increased.

Further, according to the evaluation results of the comparative examples No. 3 and No. 4, it was confirmed that, due to the good flow ability of the tranparent toner thanks to silicon dioxide contained in the composite oxide particle, the blurred image did not occur. Further, titanium dioxide contained in the composite oxide particle exhibited the charging effect. As a result, the control bias responsiveness became relatively high. Further, under the high temperature and high humidity environment (HH), due to the effect of increasing charge, the transparent toner became easier to be transported to the developing roller 104, thereby preventing the blurred image. However, in the comparative examples No. 3 and No. 4, greater than 0.3 wt % of the melamine resin particle was contained in the transparent toner. Accordingly, due to the effect of increasing charge of the melamine resin particle, the potential of the toner layer on the developing roller 104 (the LL potential) under the low temperature and low humidity environment (LL) increased.

Further, according to the evaluation results of the comparative examples No. 5 and No. 6, it was confirmed that, due to the charging effect of titanium dioxide contained in the composite oxide particle exhibited the, it was possible to obtain the control bias responsiveness at a relatively high level. Further, the low temperature and low humidity environment (LL), the potential of the toner layer on the developing roller 104 (the LL potential) was low. However, the transparent toner contained only 0.1 wt % of the melamine resin particle. Accordingly, it was difficult to secure sufficient durability of the melamine resin particle that has the large particle diameter and high hardness, thereby causing the blurred image.

On the other hand, in the examples No. 1, No. 2, No. 3, and No. 4, the outer additive agent was attached to the base toner particle, and contained between 1.0 wt % and 1.5 wt % of the composite oxide particle containing titanium dioxide and silicon dioxide and between 0.2 wt % and 0.3 wt % of the melamine resin particle. According to the evaluation results of the examples No. 1, No. 2, No. 3, and No. 4, the blurred image did not occur. Further, the transparent toner had the high environmental and charge stability and the control bias responsiveness at a high level.

In the examples No. 1, No. 2, No. 3, and No. 4, silicon dioxide contained in the composite oxide particle has the good flow ability. Further, the melamine resin particle has the large particle diameter and the high hardness, so that a space is created between the base toner particle of the transparent toner. Further, the durability is improved due to relaxation of the mechanical stress. Accordingly, it is possible to minimize the collision and the aggregation of the base toner particle of the transparent toner.

Further, in the examples No. 1, No. 2, No. 3, and No. 4, due to the effect of the charge stability of titanium oxide contained in the composite oxide particle, it is possible to stabilize the environmental charging property of the transparent toner under both the high temperature and high humidity environment (HH) and the low temperature and low humidity environment (LL).

As described above, in the embodiment, the outer additive agent is attached to the base toner particle. Further, the outer additive agent contains between 1.0 wt % and 1.5 wt % of the composite oxide particle containing titanium dioxide and silicon dioxide, and between 0.2 wt % and 0.3 wt % of the melamine resin particle. Accordingly, it is possible to improve the flow ability and the durability of the transparent toner. Even when the continuous printing operation is performed, it is possible to prevent the blurred image while securing the charge stability to the developing roller against the environmental change and the control bias responsiveness.

It should be noted that the present invention may be modified and applied to various embodiments.

In the embodiment described above, the transparent toner is produced with the solution emulsion method, and the production method of the transparent toner is not limited to the solution emulsion method. The transparent toner may be produced with other method including, for example, a melt mixture method, a suspension polymerization method, and the like.

In the melt mixture method, crashed toner is used. the crashed toner is obtained with a method including a step of melting and mixing a raw material including the bonder resin and a step of crashing. More specifically, when the crashed toner is produced with the melt mixture method, first, raw materials such as the bonder resin, the colorant agent, a charge control agent, and the like are mixed uniformly in a mixing device such as Henschel mixer and the like. In the next step, the mixture is melted and kneaded in a mixing machine such as a closed kneader, an extrusion machine with one axis or two axes, an open roll type mixing machine, and the like. Afterward, the mixture is cooled, crashed, and screened. When the transparent toner is produced with the melt mixture method, it is possible to prevent the colored toner from scattering and maintain gloss even when a small amount of the transparent toner is used.

Further, in the embodiment described above, the outer additive agent of the transparent toner contains the composite oxide particle containing titanium dioxide and silicon dioxide and the melamine resin particle. It should be noted that the outer additive agent is not limited to the transparent toner, and may be used as an outer additive agent of the toner base particle of the colored toner.

The disclosure of Japanese Patent Application No. 2013-188544, filed on Sep. 11, 2013, is incorporated in the application.

While the invention has been explained with reference to the specific embodiments of the invention, the explanation is illustrative and the invention is limited only by the appended claims.

What is claimed is:

1. Developer comprising:
a toner base particle; and
an outer additive agent attached to a surface of the toner base particle,
wherein said outer additive agent includes at least a composite oxide particle containing titanium dioxide and silicon dioxide and a melamine resin particle.

2. The developer according to claim 1, wherein said composite oxide particle is contained at a concentration between 1.0 wt % and 1.5 wt %, both inclusive, relative to the toner base particle.

3. The developer according to claim 1, wherein said melamine resin particle is contained at a concentration between 1.0 wt % and 1.5 wt %, both inclusive, relative to the toner base particle.

4. The developer according to claim 2, wherein said melamine resin particle is contained at a concentration between 1.0 wt % and 1.5 wt %, both inclusive, relative to the toner base particle.

5. The developer according to claim 1, wherein said toner base particle is produced through dispersing an oily phase in an aqueous phase to obtain an oily phase liquid droplet so that the oily phase liquid droplet is formed into the toner base particle,
said oily phase contains a binder resin and an additive dispersed or dissolved in an organic solvent, and
said aqueous phase contains an inorganic dispersion agent.

6. The developer according to claim 4, wherein said toner base particle is produced through dispersing an oily phase in an aqueous phase to obtain an oily phase liquid droplet so that the oily phase liquid droplet is formed into the toner base particle,
said oily phase contains a binder resin and an additive dispersed or dissolved in an organic solvent, and
said aqueous phase contains an inorganic dispersion agent.

7. A developer container unit configured to retain the developer according to claim 1 to be supplied to a developer supporting member for supporting the developer.

8. A developer container unit configured to retain the developer according to claim 6 to be supplied to a developer supporting member for supporting the developer.

9. A developing device configured to form a developer image on a developer supporting member using the developer according to claim 1 supplied from a developer container unit.

10. A developing device configured to form a developer image on a developer supporting member using the developer according to claim 6 supplied from a developer container unit.

11. An image forming apparatus configured to form an image through transferring a developer image to a medium,
wherein said developer image is formed on a developer supporting member using the developer according to claim 1.

12. An image forming apparatus configured to form an image through transferring a developer image to a medium,
wherein said developer image is formed on a developer supporting member using the developer according to claim 6.
